(19) United States
(12) Patent Application Publication
(10) Pub. No.: US 2016/0323599 A1
(43) Pub. Date: Nov. 3, 2016

(54) REFERENCE PICTURE SELECTION FOR INTER-PREDICTION IN VIDEO CODING

(71) Applicant: ARRIS Enterprises LLC, Suwanee, GA (US)

(72) Inventors: Fangzhou Lu, Los Angeles, CA (US); David M. Baylon, San Diego, CA (US); Krit Panusopone, San Diego, CA (US)

(21) Appl. No.: 15/142,653

(22) Filed: Apr. 29, 2016

Related U.S. Application Data
(60) Provisional application No. 62/154,202, filed on Apr. 29, 2015.

(51) Int. Cl. H04N 19/577; H04N 19/184; H04N 19/176; H04N 19/172

(52) U.S. Cl. CPC H04N 19/577; H04N 19/172; H04N 19/184; H04N 19/176

(57) ABSTRACT

A method of encoding a digital video is provided that improves inter-prediction for encoding using reference pictures. The method includes loading a sub-picture and a list of a plurality of candidate reference pictures at a video encoder, generating a plurality of candidate motion vectors by performing an integer-pel motion estimation operation, calculating a motion estimate score for each of the plurality of candidate motion vectors and selecting the one of the plurality of candidate reference pictures that is associated with the best motion estimate score as a best-match reference picture, performing additional integer-pel motion estimation operations on the best-match reference picture at one or more lower coding levels than the first coding level, refining motion vectors associated with the best-match reference picture at the first coding level and the one or more lower coding levels using fractional-pel motion estimation operations, and encoding the motion vectors into a bitstream.

### CLAIM OF PRIORITY

This application claims priority under 35 U.S.C. §119(e) from earlier filed U.S. Provisional Application Ser. No. 62/154,202, filed Apr. 29, 2015, which is hereby incorporated by reference.

### TECHNICAL FIELD

The present disclosure relates to the field of video coding, particularly a method of selecting reference pictures for encoding sub-pictures with inter-prediction.

### BACKGROUND

Video encoders often encode videos into bitstreams by breaking pictures into sub-pictures such as processing windows, slices, coding tree units (CTUs), coding units (CUs), prediction units (PUs), and/or macroblocks. Each sub-picture can then be encoded using intra-prediction and/or inter-prediction. Intra-prediction involves finding a spatial prediction mode that points to similar areas of the same picture, while inter-prediction involves finding motion vectors that point to similar areas of other pictures in the video, such as other pictures in the same group of pictures (GOP).

Most video encoding schemes encode sub-pictures with inter-prediction by performing motion estimation operations at every possible coding level on every possible reference picture, to look for a motion vector that points to a reference block that best matches the current sub-picture.

For example, in HEVC (High Efficiency Video Coding), an encoder working on encoding a CTU can perform a plurality of motion estimation operations on each potential reference picture to find motion vectors at varying levels, such as at the CTU level and for each possible division of the CTU into CUs and/or PUs. The motion vectors can then be compared to find the ones that point to the best match for the CTU, or each CU and/or PU within the CTU. Once the best motion vectors have been found for each potential reference picture, the absolute best ones across all potential reference pictures can be found.

Performing multiple motion estimation operations at all possible coding levels on all possible reference pictures can be computationally intensive. In addition, many encoding schemes add to this computational complexity by using multi-stage motion estimation operations. For example many encoders use coarse operations, such as integer-pel motion estimation operations, to find the best candidate motion vector at each possible coding level for each reference picture, and then refine the candidate motion vectors by performing even more computationally intensive fractional-pel motion estimation operations, such as half-pixel motion estimation operations or quarter-pixel motion estimation operations.

While performing multiple motion estimation operations at all possible coding levels on all possible reference pictures can result in the encoder finding the best possible motion vector for a given sub-picture, the coding complexity can grow linearly as the number of potential reference pictures grows. This can be computationally wasteful and take more time than necessary when using a motion vector that is not necessarily the best overall provides similar encoding quality.

For example, if most of the reference pictures show similar content with minor differences, there may be little difference between the absolute best match reference block across all possible reference pictures and a reference block that is not quite the best match but is still very similar. As such, taking the time to find and refine every possible motion vector across all the reference pictures may not offer significantly improved coding quality compared to using motion vectors found from a single reference picture.

### SUMMARY

What is needed is an encoding system that finds the best motion vector across all potential reference pictures at a coarse level to select a single best reference picture, and then searches for and refines motion vectors at lower levels within the selected single best reference picture.

The present disclosure provides a method of encoding a digital video, the method comprising loading a sub-picture and a list of a plurality of candidate reference pictures at a video encoder, generating a plurality of candidate motion vectors by performing an integer-pel motion estimation operation with the video encoder at a first coding level on each of the plurality of candidate reference pictures, calculating a motion estimate score for each of the plurality of candidate motion vectors with the video encoder, and selecting the one of the plurality of candidate reference pictures that is associated with the best motion estimate score as a best-match reference picture, performing additional integer-pel motion estimation operations with the video encoder on the best-match reference picture at one or more lower coding levels than the first coding level, refining motion vectors associated with the best-match reference picture at the first coding level and the one or more lower coding levels with the video encoder using fractional-pel motion estimation operations, and encoding the motion vectors into a bitstream with the video encoder.

The present disclosure also provides a method of encoding a digital video, the method comprising loading a sub-picture and a list of a plurality of candidate reference pictures at a video encoder, generating a plurality of candidate motion vectors by performing an integer-pel motion estimation operation with the video encoder at a first coding level on each of the plurality of candidate reference pictures, calculating a motion estimate score for each of the plurality of candidate motion vectors with the video encoder, selecting a plurality of best-match reference pictures, the plurality of best-match reference pictures being a subset of the plurality of candidate reference pictures that are associated with the best motion estimate scores, such that when the plurality of candidate reference pictures contains N candidate reference pictures, the plurality of best-match reference pictures contains M best-match reference pictures, where M is predetermined and 1<M<N, performing additional integer-pel motion estimation operations with the video encoder on the plurality of best-match reference pictures at one or more lower coding levels than the first coding level, refining motion vectors associated with the plurality of best-match reference pictures at the first coding level and the one or more lower coding levels with the video encoder using fractional-pel motion estimation operations, selecting the best refined motion vectors associated with the plurality of best-match reference pictures, and encoding the selected motion vectors into a bitstream with the video encoder.

The present disclosure also provides a video encoder comprising a data transmission interface configured to receive a digital video, and a processor configured to load a sub-picture from the digital video and a list of a plurality of candidate reference pictures for the sub-picture, generate a plurality of candidate motion vectors by performing an integer-pel motion estimation operation at a first coding level on each of the plurality of candidate reference pictures, calculate a motion estimate score for each of the plurality of candidate motion vectors with the video encoder, select the one of the plurality of candidate reference pictures that is associated with the best motion estimate score as a best-match reference picture, perform additional integer-pel motion estimation operations on the best-match reference picture at one or more lower coding levels than the first coding level, refine motion vectors associated with the best-match reference picture at the first coding level and the one or more lower coding using fractional-pel motion estimation operations, and encode the motion vectors into a bitstream.

### BRIEF DESCRIPTION OF THE DRAWINGS

Further details of the present invention are explained with the help of the attached drawings in which:

FIG. 1 depicts an embodiment of an encoder.

FIG. 2 depicts exemplary division of a picture into a plurality of sub-pictures.

FIG. 3 depicts a flow chart for a method of encoding sub-pictures to generate a bitstream.

FIG. 4 depicts a method for encoding a sub-picture using multi-stage inter-prediction with an encoder.

FIG. 5 depicts pseudocode for implementing the method of FIG. 4 in HEVC (High Efficiency Video Coding) when the sub-picture is a 32×32 coding unit (CU).

FIG. 6 depicts a non-limiting example of experimentally determined Bjøntegaard-Delta bit-rate (BD-rate) scores for three encoding methods relative to a control method.

### DETAILED DESCRIPTION

FIG. 1 depicts an embodiment of an encoder 100. An encoder 100 can comprise processors, memory, circuits, and/or other hardware and software elements configured to encode, transcode, and/or compress input video 102 into a bitstream 104. In some embodiments, an encoder 100 can be a dedicated hardware device. In other embodiments an encoder 100 can be, or use, software programs running on other hardware such as servers, computers, or video processing devices.

The encoder 100 can receive an input video 102 from a source, such as over a network or via local data storage from a broadcaster, content provider, or any other source. In some embodiments or situations the input video 102 can be raw and/or uncompressed video, while in other embodiments or situations the input video 102 can have been partially pre-processed or compressed by other equipment. By way of a non-limiting example, the input video 102 can be received by the encoder 100 over a network or other data connection from a broadcaster, content provider, or any other source. By way of another non-limiting example, the input video 102 can be a file loaded to the encoder 100 from a hard disk or other memory storage device connected to the encoder 100.

An input video 102 can comprise a sequence of pictures 106. For progressive video, each picture 106 can be a full frame from the input video 102. For interlaced video, each picture 106 can be either a top field or a bottom field from the input video 102. By way of a non-limiting example, in some embodiments a top field picture 106 can be the even lines from the input video 102 scanned at a first point in time, while a bottom field picture 106 can be the odd lines from the input video 102 scanned at a second point in time.

The encoder 100 can be configured to encode and/or compress pictures 106 from the input video 102 into a bitstream 104, as will be discussed further below. The encoder 100 can be configured to generate the bitstream 104 according to a video coding format and/or compression scheme, such as HEVC (High Efficiency Video Coding), H.264/MPEG-4 AVC (Advanced Video Coding), or MPEG-2. By way of a non-limiting example, in some embodiments the encoder 100 can be a Main 10 HEVC encoder. The generated bitstream 104 can be transmitted to other devices configured to decode and/or decompress the bitstream 104 for playback, such as transmission over the internet, over a digital cable television connection such as Quadrature Amplitude Modulation (QAM), or over any other digital transmission mechanism.

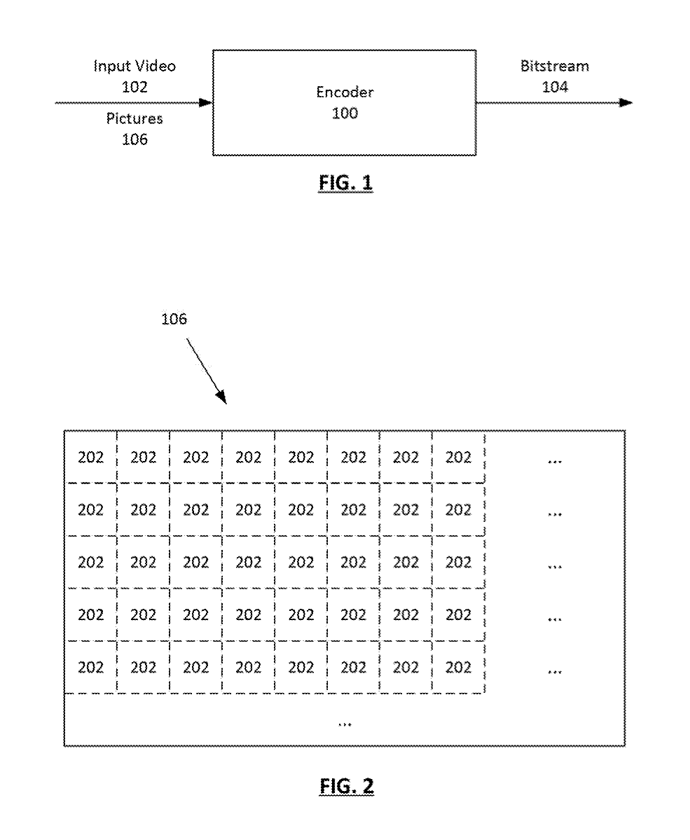

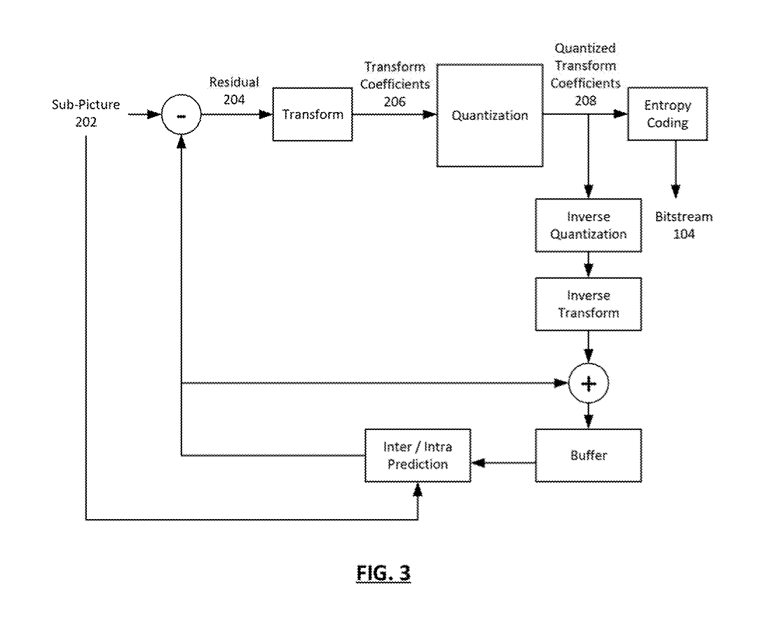

As shown in FIG. 2, in many coding schemes the pixels of a picture 106 can be divided into sub-pictures 202 that can be encoded and decoded using intra-prediction or inter-prediction. In HEVC sub-pictures 202 can be coding tree units (CTUs), or coding units (CUs) and/or prediction units (PUs) within each CTU. By way of a non-limiting example, a picture 106 can be divided into CTUs of a relatively large size, such as blocks of 64×64 pixels, 32×32 pixels, or 16×16 pixels. A CTU can be recursively divided into one or more CUs using a quadtree structure. Each CU can be divided into one or more PUs that can be encoded and decoded with intra-prediction or inter-prediction. In other coding schemes, sub-pictures 202 can be processing windows, slices, macroblocks, or any other region or area of a picture 106. When the input video 102 is a progressively scanned video 102 the sub-picture 202 can be a portion of a frame. When the input video 102 is an interlaced video, such that pictures 106 are top fields or bottom fields, a sub-picture 202 can be within a field.

Coding a sub-picture 202 with intra-prediction uses spatial prediction based on other similar sections of the same picture 106. According to the particular coding scheme, the encoder 100 can search through pixels on other parts of the picture 106 in spatial directions described by a plurality of different intra prediction modes, to find the best match for a current sub-picture 202. By way of a non-limiting example, encoding with HEVC can search through 35 different spatial directions to predict luma components of a sub-picture 202. The best intra prediction mode can be encoded in the bitstream 104 for intra-predicted sub-pictures 202. As such, spatial redundancy in the input video 102 can be reduced by pointing to similar areas in the same picture 106.

Coding a sub-picture 202 with inter-prediction uses temporal prediction to encode motion vectors that point to similar sections of a reference picture, such as a preceding or subsequent picture 106 in the same group of pictures (GOP). When the input video 102 is a progressively scanned video 102 and the sub-picture 202 is a portion of a frame, the reference picture can be another frame. When the input video 102 is an interlaced video and a sub-picture 202 is within a top or bottom field, the reference picture can also be a field. As will be discussed further below, temporal prediction can be performed through motion estimation operations that search for a best match prediction for a current sub-picture 202 over potential reference pictures. Motion vectors that point to the best match predictions in specified reference pictures can be encoded within the bitstream 104 for inter-predicted sub-pictures 202. As such, temporal redundancy in the input video 102 can be reduced by pointing to similar areas in other pictures 106.

A picture 106 with sub-pictures 202 encoded entirely with intra-prediction can be referred to as an “I-frame.” I-frames can be encoded or decoded independently from other pictures 106, as each of its sub-pictures 202 can be coded with reference to other sections of the same picture 106. Pictures 106 with at least some sub-pictures 202 encoded with inter-prediction can be referred to as “P-frames” when the inter-predicted sub-pictures 202 refer back to earlier sub-pictures 202, or as “B-frames” when the inter-predicted sub-pictures 202 refer to both earlier and subsequent sub-pictures 202. In some embodiments or situations, a GOP can begin with an I-frame and be followed by a sequence of P-frames and/or B-frames encoded with reference to other pictures 106 in the GOP.

FIG. 3 depicts a flow chart for a method of encoding sub-pictures 202 to generate a bitstream 104. As described above, a sub-picture 202 can be inter-predicted or intra-predicted based on areas within the same picture 106 or other reference pictures 106. Any differences between a sub-picture 202 and areas they reference through a prediction mode or motion vector in the same or other pictures 106 can be referred to as the sub-picture's residual 204. In addition to encoding the prediction mode or motion vector in the bitstream 104, the residual 204 can also be encoded into the bitstream as shown in FIG. 3.

The encoder 100 can perform a spatial transform on the residual 204 to produce transform coefficients 206. By way of a non-limiting example, a residual 204 can be transformed with a Discrete Cosine Transform (DCT) to produce DC and AC transform coefficients 206. Each resulting transform coefficient 206 can then be quantized into one of a finite number of possible values to convert it into a quantized transform coefficient 208. The quantized transform coefficients 208 can be encoded into the bitstream 104. In some embodiments, the quantized transform coefficients 208 can be encoded into the bitstream 104 using entropy coding. By way of a non-limiting example, in HEVC the quantized transform coefficients 206 can be entropy encoded using CABAC (context-adaptive binary arithmetic coding).

As shown in FIG. 3, quantized transform coefficients 206 can also be inverse quantized and inverse transformed, and the result can be used to create reconstructed pictures 106 and/or sub-pictures 202 that can be held as reference pictures in a buffer within the encoder 100. The encoder 100 can use the reconstructed reference pictures during inter prediction and/or intra prediction of subsequent sub-pictures 202. By way of a non-limiting example, an encoder 100 can encode a sub-picture 202 in a P-frame with reference to another picture 106 or sub-picture 202 that has already been encoded, and the encoder 100 can access and/or reference that preceding picture 106 or sub-picture 202 in the buffer when coding the new sub-picture 202.

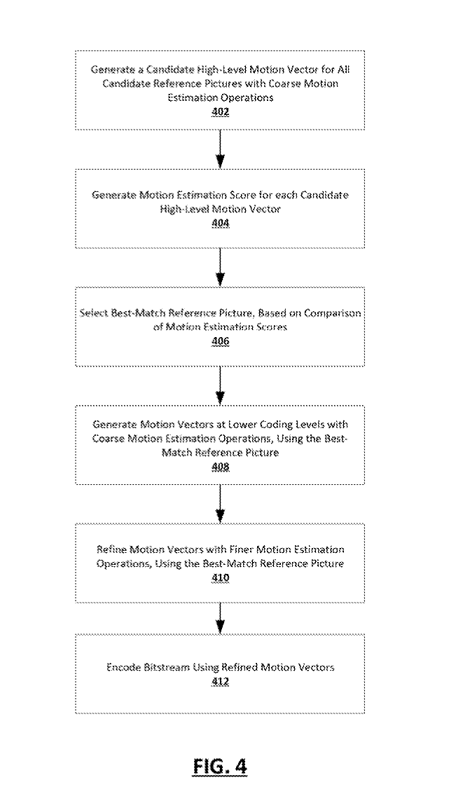

FIG. 4 depicts a method for encoding a sub-picture 202 using multi-stage inter-prediction with the encoder 100. When encoding a sub-picture 202 with inter-prediction, the encoder 100 can consider a plurality of other pictures 106 as candidate reference pictures 106. By way of a non-limiting example, the candidate reference pictures 106 can be other pictures 106 in the same GOP as the current sub-picture 202. In some embodiments, the candidate reference pictures 106 can be reconstructed pictures 106 held in the encoder's buffer, as described above. In other embodiments, the candidate reference pictures 106 can be original pictures 106 from the input video 102.

At step 402, the encoder 100 can generate a candidate high-level motion vector for each of a plurality of candidate reference pictures 106, using coarse motion estimation operations. By way of a non-limiting example, the encoder 100 can perform integer-pel motion estimation operations on each candidate reference picture 106 to find a high-level motion vector that points to a block of pixels of the same size as the sub-picture 202 that best matches the sub-picture 202 within that candidate reference picture 106.

At step 404, the encoder 100 can calculate a motion estimate score for each candidate high-level motion vector found during step 402. A motion estimate score can indicate how closely the reference block pointed to by the candidate high-level motion vector in a candidate reference picture 106 matches the current sub-picture 202, such as a measure of the error or differences between the reference block and the current sub-picture 202. By way of non-limiting examples, the motion estimate score calculated for each candidate high-resolution motion vector can be the result of a cost function or other operation such as a sum of absolute differences (SAD), a mean squared error (MSE), sum of squared error (SSE), sum of absolute transformed differences (SATD), an actual or estimated rate distortion cost (RD-cost), an average of previously encoded motion vectors for neighboring pictures 106 or sub-pictures 202, or any other metric indicating differences between the current sub-picture 202 and the reference block being compared. In some embodiments a lower motion estimate score indicates a closer match between compared pixels than a higher motion estimate score.

At step 406, the encoder 100 can find one best-match reference picture 106 out of the candidate reference pictures 106 by comparing the motion estimate scores calculated during step 404. The encoder 100 can identify the candidate reference picture 106 associated with the best motion estimate score as the best-match reference picture 106. By way of a non-limiting example, the encoder 100 can identify the best-match reference picture 106 as the candidate reference picture 106 associated with the lowest SAD value.

At step 408, the encoder 100 can perform additional coarse motion estimation operations on the best-match reference picture 106, to find motion vectors at lower levels within the sub-picture 202. By way of a non-limiting example, when the sub-picture 202 is a 32×32 CTU in HEVC, the encoder 100 can perform integer-pel motion estimation operations to find motion vectors for smaller CUs and/or PUs within the CU, such as a 16×16 pixel level, 8×8 pixel level, and/or 4×4 pixel level. The encoder 100 can adopt the candidate high-level motion vector found during step 402 for the candidate reference picture 106 ultimately found to be the best-match reference picture 106 as the motion vector for the highest level, without performing another coarse motion estimation operation at that level.

At step 410, the encoder 100 can refine the motion vectors found during steps 402 and 408 using finer motion estimation operations. By way of non-limiting examples, when the coarse motion vector operations used in steps 402 and 408 were integer-pel motion estimation operations, the encoder 100 can refine the motion vectors using fractional-pel motion estimation operations such as a half-pixel motion estimation or quarter-pixel motion estimation.

After motion vectors at each desired coding level have been found and refined for the best-match reference picture 106, the encoder 100 can encode the sub-picture 202 as described above with respect to FIG. 3.

FIG. 4 depicts steps for finding a single best-match reference picture 106 out of a single list of candidate reference pictures 106, however in some embodiments or situations the encoder 100 can find a best-match reference picture 106 for each of two or more lists of candidate reference pictures 106. In these situations, the encoder 100 can find and refine motion vectors for the best-match reference picture 106 in each of the lists, such that the encoder 100 can choose between the best-match reference pictures 106 across all the lists during encoding.

In still other embodiments or situations, the encoder 100 can find more than one best-match reference picture 106 for each list of candidate reference pictures 106. By way of a non-limiting example, when a list contains N candidate reference pictures 106, the encoder 100 can be configured to find M best-match reference pictures 106 from the list, where 1<M<N. As such, the encoder 100 can eliminate at least some reference pictures 106 from consideration before finding and refining additional motion vectors for each of the M best-match reference pictures 106 during steps 408 and 410, before finally using the best to encode the sub-picture 202 during step 412. By way of a non-limiting example, in some embodiments the encoder 100 can find two best-match reference pictures 106 from a list of candidate reference pictures 106, such as one for a top field reference and one for a bottom field reference when the input video 102 is interlaced.

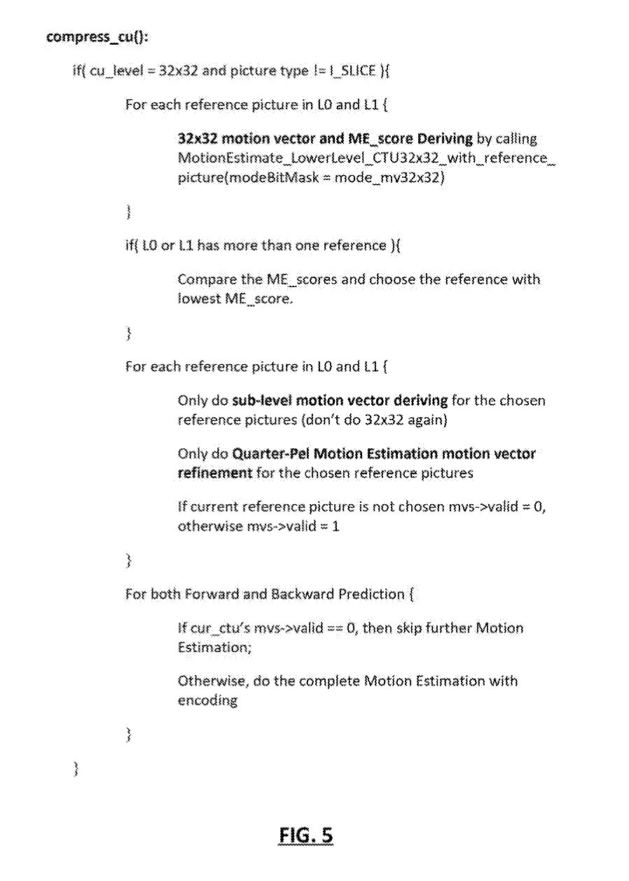

By way of a non-limiting example, FIG. 5 depicts pseudocode for implementing the method of FIG. 4 in HEVC when the sub-picture 202 is a 32×32 CU. In HEVC, the encoder 100 can have or generate two lists, denoted as List0 (L0) and List1 (L1), that each identify zero or more candidate reference pictures 106 the encoder 100 can use when encoding a sub-picture 202 with inter-prediction. As such, the encoder 100 can identify a best-match reference picture 106 from each list using the process of FIG. 4.

In this example, at step 402 the encoder 100 can perform a 32×32 integer-pel motion estimation operation on each candidate reference picture 106 in each list, to find candidate 32×32 motion vectors for each candidate reference picture 106 in each list. At step 404 the encoder 100 can find a motion estimate score for each of the candidate 32×32 motion vectors, and at step 406 select the candidate reference picture 106 with the best motion estimate score in each list as the best-match reference picture 106 for that list. In some embodiments, the encoder 100 can mark the candidate reference pictures 106 in each list as either the best-match reference picture 106 or not the best-match reference picture 106 for that list. By way of a non-limiting example, the encoder 100 can track a mvs->valid attribute for each candidate reference picture 106 in each list, and it can set mvs->valid to 0 for candidate reference pictures 106 that were not chosen as the best match in the list, while setting mvs->valid to 1 for the one found to be the best match in the list. In alternate embodiments or situations where the encoder 100 finds M best-match reference pictures 106 for each list, the encoder can set mvs->valid to 1 for each of the M candidate reference pictures 106 found to be the best matches, and mvs->valid to 0 for the other candidate reference pictures 106 that the encoder 100 determines it can drop from consideration.

Continuing with this example, at step 408 the encoder 100 can re-use the 32×32 motion vector found during step 402 for what was later determined to be the best-match reference picture 106 for each list, and also perform additional integer-pel motion estimation operations to find motion vectors for smaller CUs and/or PUs within the CU, such as a 16×16 pixel level, 8×8 pixel level, and/or 4×4 pixel level. At step 410 the encoder 100 can refine the motion vectors found during steps 402 and 408 for the best-match reference picture 106 in each list, with quarter-pixel motion estimation. By way of a non-limiting example, the encoder 100 can refine the motion vectors found for levels such as 32×32, 16×16, 8×8, and 4×4 using quarter-pixel motion estimation.

Finally, in this example, the encoder 100 can encode the sub-picture 202 using motion vectors from either or both best-match reference pictures 106. By way of a non-limiting example, a P-frame can be encoded unidirectionally by comparing the best-match reference pictures 106 from List0 and List1 and using motion vectors from the one with lower motion estimate scores. By way of another non-limiting example, a B-frame can be encoded bidirectionally using motion vectors from the best-match reference picture 106 in both List0 and List1.

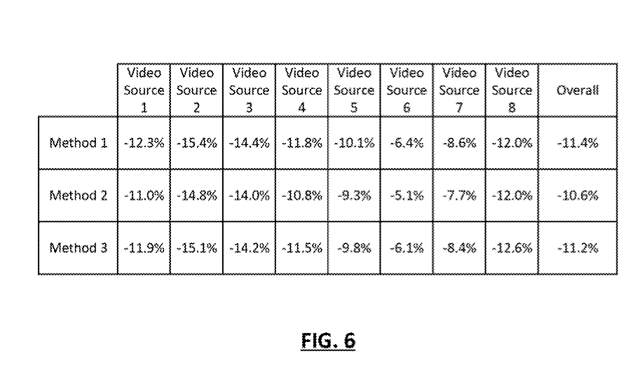

FIG. 6 depicts a non-limiting example of experimentally determined Bjøntegaard-Delta bit-rate (BD-rate) savings for three possible encoding methods that generate motion vectors from a group of three candidate reference pictures, relative to a control encoding method that generates motion vectors from a group of two candidate reference pictures.

Here, both the control method being compared against and Method 1 involve performing multiple motion estimation operations at all possible coding levels on all possible reference pictures 106, to select the best ones after all have been generated and refined. The control method performs multiple motion estimation operations at all possible coding levels on each picture 106 within a group of two candidate reference pictures 106, while Method 1 performs multiple motion estimation operations at all possible coding levels on each picture 106 within a group of three candidate reference pictures 106. As can be seen from FIG. 6, using a group of three candidate reference pictures 106 in Method 1 instead of two candidate reference pictures 106 in the control method improves BD-rates, indicating better coding efficiency as the encoder 100 can have a better chance of finding a closer match for a current sub-picture 202 from the larger group of candidate reference pictures 106.

Methods 2 and 3 also select reference pictures 106 from the same group of three candidate reference pictures 106, but pick the two best at an early stage of the encoding process rather than performing multiple motion estimation operations at all possible coding levels on all possible reference pictures 106 using quarter-pixel motion accuracy.

Method 2 follows the steps of FIG. 4 where the coarse motion estimation operation at step 402 uses 16×16 integer motion estimation based on original input reference pictures. The motion estimation score found during step 404 for a 32×32 CTU can be obtained by adding the corresponding four best 16×16 scores. The best match reference picture is then selected in step 406 by finding the one with the smallest motion estimation score determined during step 404. By using original input pictures as reference pictures, the motion estimation scores found during step 404 can be readily pre-computed and can be available for selecting the best-match reference picture in step 406 before encoding the pictures 106. As shown in FIG. 6, this method can improve on the control method since the best two out of three candidate reference pictures 106 are found and used, but has a lower coding efficiency than Method 1.

Method 3 follows the steps of FIG. 4 and is similar to Method 2, except the motion estimation operation 402 uses 32×32 integer motion estimation based on original input reference pictures to find the best high-level motion vector, followed by a 2×2 integer-pel refinement around this motion vector based on motion estimation using reconstructed reference pictures 106. The resulting motion estimation scores in step 404 are then used to select the best-match reference picture 106 in step 406. Even without fully implementing steps 408 and 410 for all reference pictures 106 to find motion vectors at lower levels and refining the motion vectors with quarter-pel motion estimation operations, the coding efficiency of Method 3 can substantially approach that of Method 1.

While Method 1 can have at least an O(n) complexity in its second stage that grows linearly relative to the number of candidate reference pictures 106, since it refines motion vectors found in a first stage using additional motion estimation and refinement operations at all possible coding levels on all possible reference pictures 106, Method 3 and the full method shown in FIG. 4 can approximate its coding efficiency with a constant O(1) complexity during the second stage. As a choice for the best-match reference picture 106 can be found in stage 1, additional coarse motion estimation operations at lower levels and more complicated fractional-pel motion estimation operations to refine the motion vectors can be performed on at most one reference picture 106 from each list. As such, the encoder's computational load can be decreased relative to Method 1, while having a substantially similar coding efficiency. Even in embodiments where the encoder 100 finds M best-match reference pictures 106 from a list of N candidate reference pictures 106, the encoder's computational load can be decreased relative to finding and refining motion vectors at multiple levels for all N pictures by eliminating N−M candidate reference pictures 106 from consideration after step 404.

Although the present invention has been described above with particularity, this was merely to teach one of ordinary skill in the art how to make and use the invention. Many additional modifications will fall within the scope of the invention, as that scope is defined by the following claims.

1. A method of encoding a digital video, comprising:
loading a sub-picture and a list of a plurality of candidate reference pictures at a video encoder;
generating a plurality of candidate motion vectors by performing an integer-pel motion estimation operation with said video encoder at a first coding level on each of said plurality of candidate reference pictures;
calculating a motion estimate score for each of said plurality of candidate motion vectors with said video encoder, and selecting the one of said plurality of candidate reference pictures that is associated with the best motion estimate score as a best-match reference picture;
performing additional integer-pel motion estimation operations with said video encoder on said best-match reference picture at one or more lower coding levels than said first coding level;
refining motion vectors associated with said best-match reference picture at said first coding level and said one or more lower coding levels with said video encoder using fractional-pel motion estimation operations; and
encoding said motion vectors into a bitstream with said video encoder.

2. The method of claim 1, wherein encoding said motion vectors into a bitstream comprises:
selecting between motion vectors associated with a first best-match reference picture found for a first list of candidate reference pictures and motion vectors associated with a second best-match reference picture found for a second list of candidate reference pictures; and
encoding the selected motion vectors into said bitstream.

3. The method of claim 2, wherein said first list is List0 in HEVC and said second list is List1 in HEVC.

4. The method of claim 1, wherein said motion estimate score is the sum of absolute differences between said sub-picture and a reference block pointed to by a candidate motion vector.

5. The method of claim 1, wherein said motion estimate score is the sum of absolute transformed differences between said sub-picture and a reference block pointed to by a candidate motion vector.

6. The method of claim 1, wherein said motion estimate score is a rate distortion cost between said sub-picture and a reference block pointed to by a candidate motion vector.

7. The method of claim 1, wherein said motion estimate score uses an average of previously encoded motion vectors for neighboring sub-pictures.

8. The method of claim 1, wherein said fractional-pel motion estimation operations are quarter-pixel motion estimation operations.

9. The method of claim 1, wherein said plurality of candidate reference pictures are original input reference pictures.

10. A method of encoding a digital video, comprising:
loading a sub-picture and a list of a plurality of candidate reference pictures at a video encoder;
generating a plurality of candidate motion vectors by performing an integer-pel motion estimation operation with said video encoder at a first coding level on each of said plurality of candidate reference pictures;
calculating a motion estimate score for each of said plurality of candidate motion vectors with said video encoder;
selecting a plurality of best-match reference pictures, said plurality of best-match reference pictures being a subset of said plurality of candidate reference pictures that are associated with the best motion estimate scores, such that when said plurality of candidate reference pictures contains N candidate reference pictures, said plurality of best-match reference pictures contains M best-match reference pictures, where M is predetermined and 1<M<N;
performing additional integer-pel motion estimation operations with said video encoder on said plurality of best-match reference pictures at one or more lower coding levels than said first coding level;
refining motion vectors associated with said plurality of best-match reference pictures at said first coding level and said one or more lower coding levels with said video encoder using fractional-pel motion estimation operations;
selecting the best refined motion vectors associated with said plurality of best-match reference pictures; and
encoding the selected motion vectors into a bitstream with said video encoder.

11. The method of claim 10, wherein said fractional-pel motion estimation operations are quarter-pixel motion estimation operations.

12. The method of claim 10, wherein said plurality of candidate reference pictures are original input reference pictures.

13. A video encoder, comprising:
a data transmission interface configured to receive a digital video; and
a processor configured to:
load a sub-picture from said digital video and a list of a plurality of candidate reference pictures for said sub-picture;
generate a plurality of candidate motion vectors by performing an integer-pel motion estimation operation at a first coding level on each of said plurality of candidate reference pictures;
calculate a motion estimate score for each of said plurality of candidate motion vectors with said video encoder;
select the one of said plurality of candidate reference pictures that is associated with the best motion estimate score as a best-match reference picture;
perform additional integer-pel motion estimation operations on said best-match reference picture at one or more lower coding levels than said first coding level;
refine motion vectors associated with said best-match reference picture at said first coding level and said one or more lower coding using fractional-pel motion estimation operations; and
encode said motion vectors into a bitstream.

14. The video encoder of claim 13, wherein encoding said motion vectors into a bitstream comprises:
selecting between motion vectors associated with a first best-match reference picture found for a first list of candidate reference pictures and motion vectors associated with a second best-match reference picture found for a second list of candidate reference pictures; and
encoding the selected motion vectors into said bitstream.

15. The video encoder of claim 14, wherein said first list is List0 in HEVC and said second list is List1 in HEVC.

16. The video encoder of claim 13, wherein said motion estimate score is the sum of absolute differences between said sub-picture and a reference block pointed to by a candidate motion vector.

17. The video encoder of claim 13, wherein said motion estimate score is the sum of absolute transformed differences between said sub-picture and a reference block pointed to by a candidate motion vector.

18. The video encoder of claim 13, wherein said motion estimate score is a rate distortion cost between said sub-picture and a reference block pointed to by a candidate motion vector.

19. The video encoder of claim 13, wherein said motion estimate score uses an average of previously encoded motion vectors for neighboring sub-pictures.

20. The video encoder of claim 13, wherein said fractional-pel motion estimation operations are quarter-pixel motion estimation operations.
